(19) United States
(12) Patent Application Publication
(10) Pub. No.: US 2026/0106174 A1
(43) Pub. Date: Apr. 16, 2026

(54) CURRENT COLLECTOR AND BATTERY

(71) Applicant: Toyota Jidosha Kabushiki Kaisha, Toyota-shi (JP)

(72) Inventors: Ryuto SAKAMOTO, Okazaki-shi (JP); Tetsuya Mimura, Chiryu-shi (JP); Atsushi Sugihara, Toyota-shi (JP); Satoshi Moriyama, Nagoya-shi (JP); Masayoshi Haga, Nagoya-shi (JP); Masaki Furukawa, Toyota-shi (JP); Keita Yamashita, Nagoya-shi (JP); Hideyuki Nagai, Nagoya-shi (JP)

(73) Assignee: Toyota Jidosha Kabushiki Kaisha, Toyota-shi (JP)

(21) Appl. No.: 19/245,625

(22) Filed: Jun. 23, 2025

(30) Foreign Application Priority Data
Oct. 16, 2024 (JP) 2024-180951

(51) Int. Cl. H01M 4/66; H01M 4/74; H01M 50/538

(52) U.S. Cl. CPC H01M 4/668; H01M 4/667; H01M 4/745; H01M 50/538

(57) ABSTRACT

A current collector includes a support layer, a first conductive layer, and a tab. The support layer is made of a resin composition having electrical insulation properties. The first conductive layer is laminated on the support layer. The tab includes a first fixed part and a first extended part. The first fixed part and the first extended part are made of metal. The first fixed part and the first extended part are provided integrally. The first fixed part extends along the first conductive layer. The first extended part is extended from the first fixed part. The first fixed part includes a plurality of first protruding portions. The first fixed part is fixed on the first conductive layer by the first protruding portions penetrating into the first conductive layer.

### CROSS-REFERENCE TO RELATED APPLICATION

This application claims priority to Japanese Patent Application No. 2024-180951 filed on Oct. 16, 2024. The disclosure of the above-identified application, including the specification, drawings, and claims, is incorporated by reference herein in its entirety.

### BACKGROUND

### 1. Technical Field

The present disclosure relates to a current collector and a battery.

### 2. Description of Related Art

Japanese Unexamined Patent Application Publication (Translation of PCT Application) No. 2024-510696 (JP 2024-510696 A) discloses a polar plate. The polar plate includes a current collector, an active material layer, and an electrical connection member. The current collector includes a support layer and a conductive layer. The conductive layer is installed on one surface of the support layer. In the current collector, the conductive layer fulfills functions of conducting electricity and collecting a current and provides electrons for the active material layer. The electrical connection member and the current collector are connected to each other by welding at an edge of the current collector.

### SUMMARY

Conventionally, a conductive layer and a tab-shaped electrical connection member are joined to each other by welding. Welding requires heating. Thus, joining the conductive layer and the electrical connection member to each other requires relatively high energy.

The present disclosure has been made in view of this problem, and an object thereof is to provide a current collector and a battery that can reduce the energy required to join the conductive layer and the tab to each other.

A current collector according to one aspect of the present disclosure includes a support layer, a first conductive layer, and a tab. The support layer is made of a resin composition having electrical insulation properties. The first conductive layer is laminated on the support layer. The tab includes a first fixed part and a first extended part. The first fixed part and the first extended part are made of metal. The first fixed part and the first extended part are provided integrally. The first fixed part extends along the first conductive layer. The first extended part is extended from the first fixed part. The first fixed part includes a plurality of first protruding portions. The first fixed part is fixed on the first conductive layer by the first protruding portions penetrating into the first conductive layer.

A battery according to one aspect of the present disclosure includes an electrode body and an external terminal. The electrode body includes a first electrode, a second electrode, and a separator. The first electrode includes a current collector and an active material layer. The current collector includes a support layer, a first conductive layer, and a tab. The support layer is made of a resin composition having electrical insulation properties. The first conductive layer is laminated on the support layer. The tab includes a first fixed part and a first extended part. The first fixed part and the first extended part are made of metal. The first fixed part and the first extended part are provided integrally. The first fixed part extends along the first conductive layer. The first extended part is extended from the first fixed part. The first fixed part includes a plurality of first protruding portions. The first fixed part is fixed on the first conductive layer by the first protruding portions penetrating into the first conductive layer. The active material layer is laminated on the first conductive layer. The separator is laminated on the active material layer. The second electrode is laminated on the active material layer through the separator. The external terminal is electrically connected to the tab.

According to the present disclosure, the energy required to join the conductive layer and the tab to each other can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a battery according to one embodiment;

FIG. 2 is a sectional view of an electrode body of FIG. 1 as seen in the arrow direction of line II-II;

FIG. 3 is a sectional view of the electrode body of FIG. 1 as seen in the arrow direction of line III-III;

FIG. 4 is a schematic sectional view of part of the electrode body of FIG. 1 as seen in the arrow direction of line IV-IV;

FIG. 5 is a developed view of a first electrode; and

FIG. 6 is a schematic sectional view showing a close-up of part of the first electrode.

### DETAILED DESCRIPTION OF EMBODIMENTS

In the following, a battery and a current collector according to one embodiment of the present disclosure will be described with reference to the drawings. The same or corresponding parts in the drawings are denoted by the same reference signs and description thereof will not be repeated.

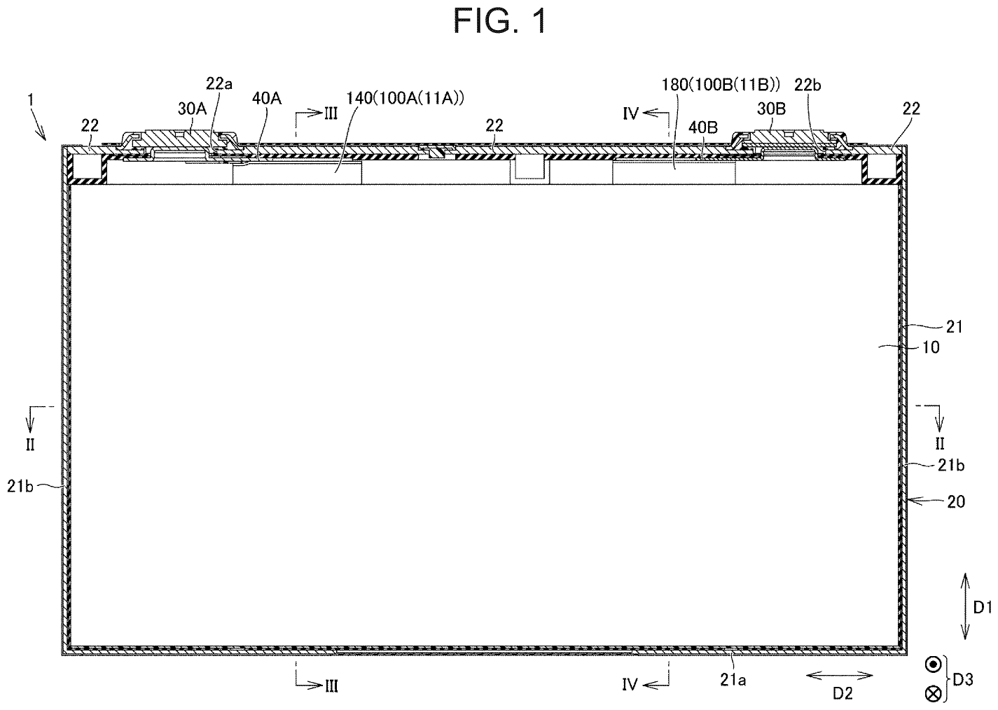

FIG. 1 is a sectional view showing the battery according to one embodiment. A battery 1 shown in FIG. 1 is a so-called rectangular battery. The battery 1 may be a secondary battery configured to be chargeable and dischargeable, such as a lithium-ion battery or a nickel-metal hydride battery. The battery 1 can be used as, for example, a cell included in an electricity storage module installed in an electrified vehicle.

As shown in FIG. 1, the battery 1 according to one embodiment of the present disclosure includes an electrode body 10, a case 20, a first external terminal 30A, a second external terminal 30B, a first coupling member 40A, and a second coupling member 40B. First, components of the battery 1 other than the electrode body 10 will be described.

The case 20 has electrical conductivity. A part of the case 20 that has electrical conductivity is made of metal, for example, aluminum. The case 20 houses the electrode body 10. The case 20 also houses an electrolytic solution (not shown).

The case 20 includes a case main body 21 and a lid 22. The case main body 21 includes a bottom wall 21a and a peripheral wall 21b rising from the bottom wall 21a.

The lid 22 is joined to the peripheral wall 21b by welding or the like so as to close an opening of the peripheral wall 21b. In the lid 22, a first coupling hole 22a and a second coupling hole 22b are formed.

The first external terminal 30A and the second external terminal 30B are provided in the battery 1 so as to be exposed to an outside. The first coupling member 40A and the second coupling member 40B have electrical conductivity. At least part of each of the first coupling member 40A and the second coupling member 40B is disposed inside the case 20.

The first external terminal 30A or the first coupling member 40A is inserted through the first coupling hole 22a. The first external terminal 30A is electrically connected to the first coupling member 40A. Specifically, the first external terminal 30A and the first coupling member 40A are joined to each other. The first coupling member 40A is joined to the electrode body 10. Thus, the first external terminal 30A is electrically connected to the electrode body 10.

The second external terminal 30B or the second coupling member 40B is inserted through the second coupling hole 22b. The second external terminal 30B is electrically connected to the second coupling member 40B. Specifically, the second external terminal 30B and the second coupling member 40B are joined to each other. The second coupling member 40B is joined to the electrode body 10. Thus, the second external terminal 30B is electrically connected to the electrode body 10.

In this embodiment, the first external terminal 30A is a positive electrode terminal and the second external terminal 30B is a negative electrode terminal. The first external terminal 30A and the second external terminal 30B lie next to each other in a second direction D2. The second direction D2 is a direction orthogonal to a first direction D1.

Next, the electrode body 10 will be described. The battery 1 according to this embodiment includes a plurality of electrode bodies 10. The battery 1 typically includes two electrode bodies 10. The electrode bodies 10 lie next to each other in a third direction D3. The third direction D3 is a direction orthogonal to both the first direction D1 and the second direction D2.

In the following, one electrode body 10 of the electrode bodies 10 will be described. Each of the electrode bodies 10 may include a configuration to be shown below.

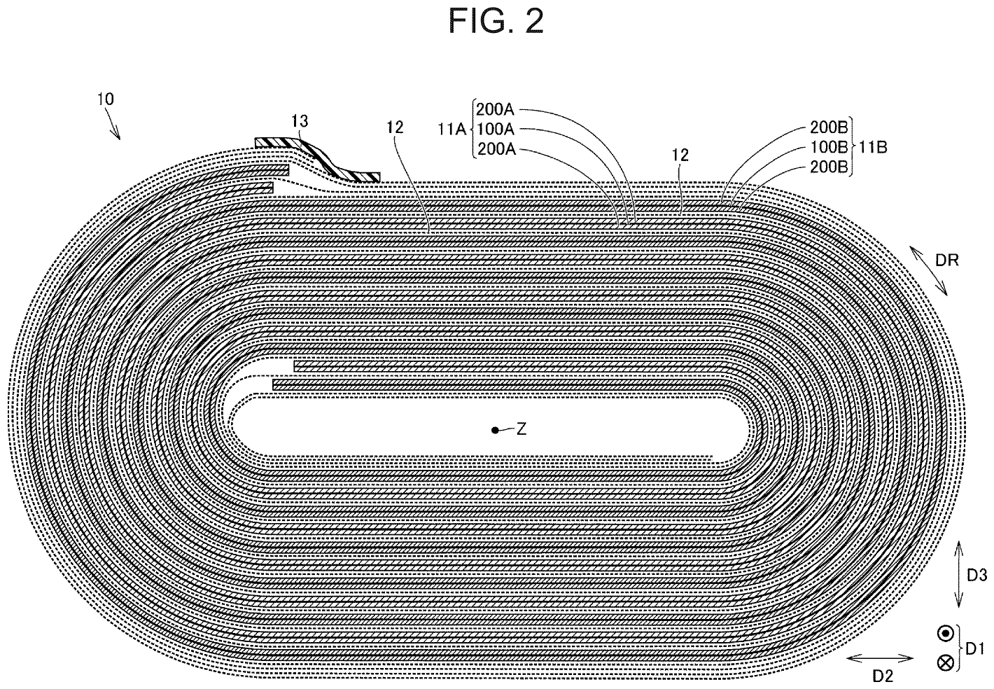

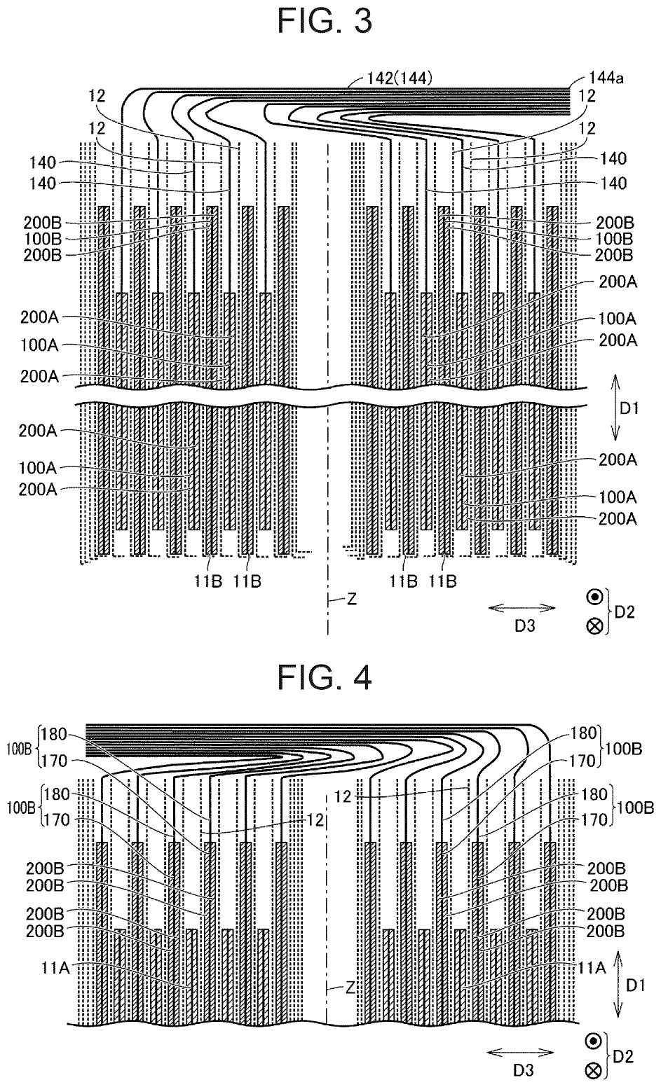

FIG. 2 is a sectional view of the electrode body of FIG. 1 as seen in the arrow direction of line II-II. FIG. 3 is a sectional view of the electrode body of FIG. 1 as seen in the arrow direction of line III-III. FIG. 4 is a schematic sectional view of part of the electrode body of FIG. 1 as seen in the arrow direction of line IV-IV. As shown in FIG. 1 to FIG. 4, the electrode body 10 includes a first electrode 11A, a second electrode 11B, and a separator 12. In the electrode body 10, the first electrode 11A, the second electrode 11B, and the separator 12 are rolled so as to surround a rolling axis Z. Thus, in this embodiment, the electrode body 10 is a so-called rolled electrode body. However, the electrode body 10 may instead be a laminated electrode body in which the first electrode 11A, the second electrode 11B, and the separator 12 are laminated in one direction (e.g., the third direction D3). In FIG. 2 to FIG. 4, the separator 12 is schematically indicated by broken lines.

The first electrode 11A and the second electrode 11B have a sheet-like external shape. The electrode body 10 is formed by a polar plate group in which the first electrode 11A and the second electrode 11B are rolled with one or more separators 12 interposed therebetween.

In this embodiment, the first electrode 11A is a positive electrode and the second electrode 11B is a negative electrode. However, instead, the first electrode 11A may be a negative electrode and the second electrode 11B may be a positive electrode.

The separator 12 is provided between the first electrode 11A and the second electrode 11B. The separator 12 separates the first electrode 11A and the second electrode 11B from each other while allowing ions to travel to and from between the first electrode 11A and the second electrode 11B. These ions are, for example, lithium ions. The separator 12 has electrical insulation properties.

Of the first electrode 11A, the second electrode 11B, and the separator 12, the separator 12 is located farthest on an inner circumferential side around the rolling axis Z. Of the first electrode 11A, the second electrode 11B, and the separator 12, the separator 12 is located farthest on an outer circumferential side around the rolling axis Z. An end edge of the separator 12 on the outer circumferential side in a rolling direction DR is fixed by a tape member 13 disposed on an outer circumferential surface of the separator 12.

The separator 12 may contain, for example, polyolefin-based resin. The separator 12 may be, for example, essentially made of polyolefin-based resin. The polyolefin-based resin may contain, for example, at least one type selected from a group consisting of polyethylene (PE) and polypropylene (PP).

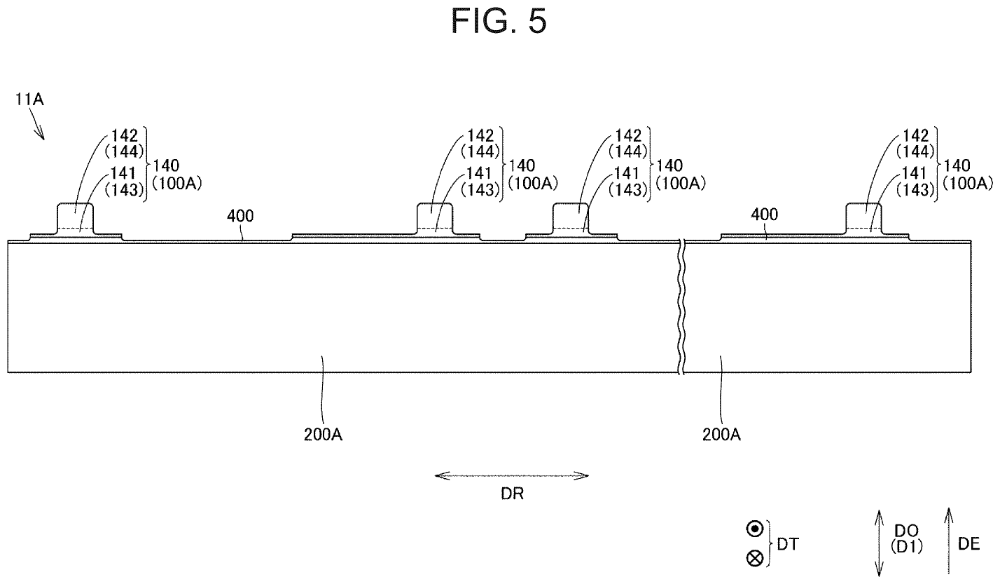

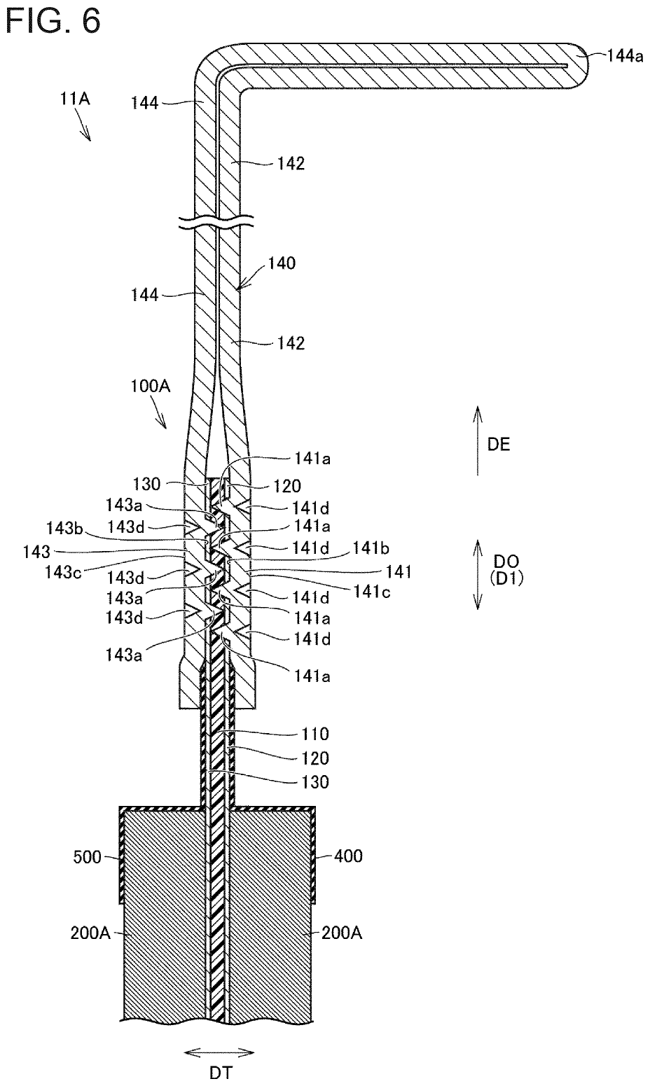

FIG. 5 is a developed view of the first electrode. That is, FIG. 5 shows a state of the first electrode 11A before being rolled. FIG. 6 is a schematic sectional view showing a close-up of part of the first electrode. The sectional view of FIG. 6 is shown as seen in a section similar to FIG. 3.

As shown in FIG. 3 to FIG. 6, the first electrode 11A includes a current collector 100A, a first active material layer 200A, a first protective part 400, and a second protective part 500.

The current collector 100A includes a support layer 110, a first conductive layer 120, a second conductive layer 130, and a plurality of tabs 140.

The support layer 110 is made of a resin composition having electrical insulation properties. Thus, the first current collector 100A is a composite current collector composed of a conductive member and an electrically insulative member. As such, compared with when the first current collector 100A is entirely made of metal, the first current collector 100A is lighter and the safety of the entire battery 1 is higher.

The support layer 110 is made of, for example, a resin composition containing polyamide-based resin, polyester-based resin, or polyolefin-based resin. To enhance the rigidity, it is preferable that the support layer 110 be made of a resin composition containing polyester-based resin. It is further preferable that the support layer 110 be essentially made of polyester-based resin. This polyester-based resin may be, for example, polyethylene terephthalate. Thus, the rigidity of the first current collector 100A can be enhanced while the electrical insulation properties of the support layer 110 are maintained. Consequently, the support layer 110 can be made relatively thin.

An orthogonal direction DO orthogonal to a thickness direction DT of the support layer 110 is substantially parallel to the first direction D1. That is, the support layer 110 extends substantially parallel to the first direction D1.

To reduce the thickness of the entire electrode body 10, the thickness of the support layer 110 is, for example, preferably 20 μm or smaller, more preferably 15 μm or smaller, and further preferably 10 μm or smaller. The thickness of the support layer 110 is not particularly limited as long as desired rigidity is secured. The thickness of the support layer 110 should be, for example, 2 μm or larger.

The first conductive layer 120 is laminated on the support layer 110. The first conductive layer 120 is provided on one face of the support layer 110. The first conductive layer 120 is provided over the entire one face.

In this embodiment, the first conductive layer 120 is located on the side of the rolling axis Z as seen from the support layer 110. However, the first conductive layer 120 may instead be located on the opposite side from the side of the rolling axis Z as seen from the support layer 110.

The second conductive layer 130 is located on the opposite side from the first conductive layer 120 as seen from the support layer 110. The second conductive layer 130 is laminated on the support layer 110. That is, the second conductive layer 130 is provided on the other face of the support layer 110. The second conductive layer 130 is provided over the entire other face.

The thickness of the first conductive layer 120 and the thickness of the second conductive layer 130 are smaller than the thickness of the support layer 110. To reduce the thickness of the entire electrode body 10, the thickness of the first conductive layer 120 and the thickness of the second conductive layer 130 are, for example, 5 μm or smaller, more preferably 2 μm or smaller, and further preferably 1 μm or smaller. To keep the electrical resistance of the first conductive layer 120 and the second conductive layer 130 from becoming too high, the thickness of the first conductive layer 120 and the thickness of the second conductive layer 130 should be, for example, 0.1 μm or larger. When the thickness of the first conductive layer 120 and the thickness of the second conductive layer 130 are 5 μm or smaller, it is difficult to directly weld the first conductive layer 120 and the second conductive layer 130 to each other, or to directly join these layers to each other by ultrasonic welding.

The formation method of the first conductive layer 120 and the second conductive layer 130 is not particularly limited. Typically, the first conductive layer 120 and the second conductive layer 130 may be provided on the support layer 110 by a vapor-deposition method or the like. The first conductive layer 120 and the second conductive layer 130 may be formed by metal films. In this case, the first conductive layer 120 and the second conductive layer 130 may be bonded to the support layer 110 through a resin adhesive.

The first conductive layer 120 and the second conductive layer 130 are typically made of metal containing aluminum. Thus, the first current collector 100A including the first conductive layer 120 and the second conductive layer 130 can be suitably used as a positive electrode current collector. Alternatively, the first current collector 100A may be a negative electrode current collector, and the first conductive layer 120 and the second conductive layer 130 may be made of metal containing copper.

As shown in FIG. 5, the tabs 140 lie next to one another in the rolling direction DR of the electrode body 10. The tabs 140 are spaced apart from one another.

As shown in FIG. 3, the tabs 140 lie next to one another in the third direction D3. The tabs 140 are joined to one another by ultrasonic joining or the like. Further, as shown in FIG. 1, the tabs 140 are joined to the first coupling member 40A by ultrasonic joining or the like. Thus, the first external terminal 30A is electrically connected to the tabs 140. In the following, a configuration of each of the tabs 140 will be described.

As shown in FIG. 6, the tab 140 includes a first fixed part 141, a first extended part 142, a second fixed part 143, and a second extended part 144.

The first fixed part 141 and the first extended part 142 are made of metal. The first fixed part 141 and the first extended part 142 are typically made of metal containing aluminum or copper. The first fixed part 141 and the first extended part 142 are formed by, for example, metal films. The first fixed part 141 and the first extended part 142 are provided integrally.

The first fixed part 141 extends along the first conductive layer 120. That is, the first fixed part 141 extends along the orthogonal direction DO on the first conductive layer 120.

The first fixed part 141 includes a plurality of first protruding portions 141a, a first face 141b, a second face 141c, and a plurality of first recessed portions 141d.

The first fixed part 141 is fixed on the first conductive layer 120 by the first protruding portions 141a penetrating into the first conductive layer 120. To more firmly fix the first fixed part 141 and the first conductive layer 120 to each other, a resin adhesive may be provided between the first fixed part 141 and the first conductive layer 120. However, to make the current collector 100A less expensive, the resin adhesive may not be provided. The first fixed part 141 and the first conductive layer 120 may be joined to each other by ultrasonic joining. However, to make the current collector 100A less expensive, the first fixed part 141 and the first conductive layer 120 may not be ultrasonically joined to each other.

The first protruding portions 141a penetrate through the first conductive layer 120. The first protruding portions 141a further penetrate into the support layer 110. The first protruding portions 141a further penetrate through the support layer 110. The first protruding portions 141a may penetrate through the support layer 110 by fitting in a plurality of through-holes that is provided in the support layer 110 beforehand.

The first face 141b faces the first conductive layer 120. The first face 141b is in contact with the first conductive layer 120. The first protruding portions 141a are provided in the first face 141b.

The second face 141c is an opposite face of the first face 141b. The first recessed portions 141d are provided in the second face 141c. The first recessed portions 141d lie next to one another so as to correspond one-for-one to the first protruding portions 141a.

The first extended part 142 is extended from the first fixed part 141. An extension direction DE of the first extended part 142 is essentially parallel to the orthogonal direction DO (first direction D1). The first extended part 142 does not lie next to the support layer 110 in the thickness direction DT.

The second fixed part 143 and the second extended part 144 are made of metal. The second fixed part 143 and the second extended part 144 are typically made of metal containing aluminum or copper. The second fixed part 143 and the second extended part 144 are formed by, for example, metal films. The second fixed part 143 and the second extended part 144 are provided integrally.

The second fixed part 143 extends along the second conductive layer 130. That is, the second fixed part 143 extends along the orthogonal direction DO on the second conductive layer 130.

The second fixed part 143 includes a plurality of second protruding portions 143a, a third face 143b, a fourth face 143c, and a plurality of second recessed portions 143d.

The second fixed part 143 is fixed on the second conductive layer 130 by the second protruding portions 143a penetrating into the second conductive layer 130. To more firmly fix the second fixed part 143 and the second conductive layer 130 to each other, a resin adhesive may be provided between the second fixed part 143 and the second conductive layer 130. However, to make the current collector 100A less expensive, the resin adhesive may not be provided. The second fixed part 143 and the second conductive layer 130 may be joined to each other by ultrasonic joining. The second fixed part 143 and the second conductive layer 130 can be further firmly fixed to each other by an anchor effect of ultrasonic joining. However, to make the current collector 100A less expensive, the second fixed part 143 and the second conductive layer 130 may not be ultrasonically joined to each other.

The second protruding portions 143a penetrate through the second conductive layer 130. The second protruding portions 143a further penetrate into the support layer 110. The second protruding portions 143a further penetrate through the support layer 110. The second protruding portions 143a may penetrate through the support layer 110 by fitting in through-holes that are provided in the support layer 110 beforehand.

The third face 143b faces the second conductive layer 130. The second protruding portions 143a are provided in the third face 143b.

The fourth face 143c is an opposite face of the third face 143b. The second recessed portions 143d are provided in the fourth face 143c. The second recessed portions 143d lie next to one another so as to correspond one-for-one to the second protruding portions 143a.

The second extended part 144 is extended from the second fixed part 143. A direction in which the second extended part 144 is extended is essentially parallel to the extension direction DE. The second extended part 144 extends as a whole along the first extended part 142. The second extended part 144 continues to the first extended part 142 at an end portion 144a on the opposite side from the side of the second fixed part 143. The second extended part 144 is provided integrally with the first extended part 142.

Thus, in this embodiment, the tab 140 is formed as a whole by one sheet of metal film that is folded back at the end portion 144a. Joined to the first coupling member 40A are the first extended part 142 and the second extended part 144.

The thickness of the tab 140 (the thickness of each of the first fixed part 141, the first extended part 142, the second fixed part 143, and the second extended part 144) is larger than the thickness of the first conductive layer 120 and the thickness of the second conductive layer 130. The thickness of the tab 140 is, for example, preferably 20 μm or smaller, more preferably 15 μm or smaller, and further preferably 10 μm or smaller. The thickness of the tab 140 is not particularly limited as long as desired rigidity is secured. The thickness of the tab 140 should be, for example, 2 μm or larger.

The first active material layer 200A is laminated on the first conductive layer 120 and the second conductive layer 130. The first active material layer 200A is a positive electrode active material layer, but may instead be a negative electrode active material layer. The first active material layer 200A is spaced apart from the tab 140.

The separator 12 is laminated on the first active material layer 200A in a radial direction around the rolling axis Z (see FIG. 3 etc.).

The first protective part 400 is made of ceramic having electrical insulation properties. The first protective part 400 covers part of the first active material layer 200A laminated on the first conductive layer 120 on the side of the extension direction DE. The first protective part 400 covers an entire surface of the first conductive layer 120 between the first active material layer 200A and the first fixed part 141. The first protective part 400 is also partially disposed between the first conductive layer 120 and the first fixed part 141.

The second protective part 500 is made of ceramic having electrical insulation properties. The second protective part 500 covers part of the first active material layer 200A laminated on the second conductive layer 130 on the side of the extension direction DE. The second protective part 500 covers an entire surface of the second conductive layer 130 between the first active material layer 200A and the second fixed part 143. The second protective part 500 is also partially disposed between the second conductive layer 130 and the second fixed part 143.

As shown in FIG. 2 to FIG. 4, the second electrode 11B is laminated on the first active material layer 200A through the separator 12 in the radial direction. While in this embodiment the electrode body 10 includes more than one separator 12, it may instead include one separator 12.

The second electrode 11B includes a second current collector 100B and a second active material layer 200B. The second current collector 100B includes a conductive support part 170 and a plurality of second tab parts 180 (see FIG. 4). The conductive support part 170 extends along the orthogonal direction DO (first direction D1). The second tab parts 180 extend from an upper end of the conductive support part 170. The second tab parts 180 are joined to one another and to the second coupling member 40B by ultrasonic welding (see FIG. 1).

The second tab parts 180 and the conductive support part 170 are formed by integral members, and are formed by, for example, metal films. In this embodiment, the second tab parts 180 and the conductive support part 170 are made of, for example, metal containing copper. Thus, the second current collector 100B can be suitably used as a negative electrode current collector. When the first current collector 100A is a negative electrode current collector and the second current collector 100B is a positive electrode current collector, the second tab parts 180 and the conductive support part 170 may be made of metal containing aluminum.

The second active material layer 200B is laminated on both surfaces of the conductive support part 170 of the second current collector 100B. In this embodiment, the second electrode 11B is a negative electrode. Therefore, the second active material layer 200B is a negative electrode active material layer. The second active material layer 200B may instead be a positive electrode active material layer.

As has been described above, in the current collector 100A according to one embodiment of the present disclosure, the first fixed part 141 is fixed on the first conductive layer 120 by the first protruding portions 141a penetrating into the first conductive layer 120.

In this configuration, since the first protruding portions 141a are mechanically connected to the first conductive layer 120, the first conductive layer 120 and the first fixed part 141 can be fixed to each other without necessarily requiring welding or ultrasonic joining. Thus, the current collector 100A in which the energy required to join the first conductive layer 120 and the tab 140 to each other is reduced, and the battery 1 including the current collector 100A can be provided.

In the embodiment, the first fixed part 141 further includes the first face 141b, the second face 141c, and the first recessed portions 141d. The first face 141b faces the first conductive layer 120. The first protruding portions 141a are provided in the first face 141b. The second face 141c is the opposite face of the first face 141b. The first recessed portions 141d are provided in the second face 141c. The first recessed portions 141d lie next to one another so as to correspond one-for-one to the first protruding portions 141a.

This configuration makes it also possible to form the first protruding portions 141a together with the first recessed portions 141d by embossing. Consequently, the first protruding portions 141a can be relatively easily formed in the first fixed part 141.

In the embodiment, the first protruding portions 141a penetrate through the first conductive layer 120. The first protruding portions 141a further penetrate into the support layer 110.

In this configuration, the tab 140 can also be fixed to the support layer 110, and can be thereby more firmly fixed to the first conductive layer 120.

In the embodiment, the current collector 100A further includes the second conductive layer 130. The second conductive layer 130 lies on the opposite side from the first conductive layer 120 as seen from the support layer 110. The second conductive layer 130 is laminated on the support layer 110. The tab 140 further includes the second fixed part 143 and the second extended part 144. The second fixed part 143 and the second extended part 144 are made of metal. The second fixed part 143 and the second extended part 144 are provided integrally. The second fixed part 143 extends along the second conductive layer 130. The second extended part 144 is extended from the second fixed part 143. The second fixed part 143 includes the second protruding portions 143a, the third face 143b, the fourth face 143c, and the second recessed portions 143d. The second fixed part 143 is fixed on the second conductive layer 130 by the second protruding portions 143a penetrating into the second conductive layer 130. The third face 143b faces the second conductive layer 130. The second protruding portions 143a are provided in the third face 143b. The fourth face 143c is the opposite face of the third face 143b. The second recessed portions 143d are provided in the fourth face 143c. The second recessed portions 143d lie next to one another so as to correspond one-for-one to the second protruding portions 143a. The first protruding portions 141a penetrate through the first conductive layer 120. The first protruding portions 141a further penetrate into the support layer 110. The second protruding portions 143a penetrate through the second conductive layer 130. The second protruding portions 143a further penetrate into the support layer 110. The second extended part 144 continues to the first extended part 142 at the end portion 144a on the opposite side from the side of the second fixed part 143. The second extended part 144 is provided integrally with the first extended part 142.

In this configuration, even when there are conductive layers on both faces of the support layer 110, the second protruding portions 143a are mechanically connected to the second conductive layer 130. Therefore, the second conductive layer 130 and the second fixed part 143 can be fixed to each other without necessarily requiring welding or ultrasonic joining. Thus, the energy required to join the second conductive layer 130 and the tab 140 to each other can be reduced. Further, this configuration makes it also possible to form the second protruding portions 143a together with the second recessed portions 143d by embossing. Consequently, the second protruding portions 143a can be relatively easily formed in the second fixed part 143. Further, as the second extended part 144 continues to the first extended part 142 and is provided integrally with the first extended part 142, the tab 140 can be formed as a whole by one member. Consequently, an increase in the number of members composing the current collector 100A can be avoided to thereby provide the current collector 100A and the battery 1 including the current collector 100A that are less expensive.

In the description of the embodiment given above, configurations that can be combined may be combined with one another.

The embodiment disclosed this time should be construed as being in every respect illustrative and not restrictive. The scope of the present disclosure is indicated not by the above description but by the claims, and is intended to include all changes within the meaning and scope of equivalents of the claims.

What is claimed is:

1. A current collector comprising:
a support layer;
a first conductive layer; and
a tab, wherein:
the support layer is made of a resin composition having electrical insulation properties;
the first conductive layer is laminated on the support layer;
the tab includes a first fixed part and a first extended part;
the first fixed part and the first extended part are made of metal and provided integrally;
the first fixed part extends along the first conductive layer;
the first extended part is extended from the first fixed part;
the first fixed part includes a plurality of first protruding portions; and
the first fixed part is fixed on the first conductive layer by the first protruding portions penetrating into the first conductive layer.

2. The current collector according to claim 1, wherein:
the first fixed part further includes a first face, a second face, and a plurality of first recessed portions;
the first face faces the first conductive layer;
the first protruding portions are provided in the first face;
the second face is an opposite face of the first face; and
the first recessed portions are provided in the second face and lie next to one another so as to correspond one-for-one to the first protruding portions.

3. The current collector according to claim 1, wherein:
the first protruding portions penetrate through the first conductive layer; and
the first protruding portions further penetrate into the support layer.

4. The current collector according to claim 2, further comprising a second conductive layer, wherein:
the second conductive layer lies on the opposite side from the first conductive layer as seen from the support layer and is laminated on the support layer;
the tab further includes a second fixed part and a second extended part;
the second fixed part and the second extended part are made of metal and provided integrally;
the second fixed part extends along the second conductive layer;
the second extended part is extended from the second fixed part;
the second fixed part includes a plurality of second protruding portions, a third face, a fourth face, and a plurality of second recessed portions;
the second fixed part is fixed on the second conductive layer by the second protruding portions penetrating into the second conductive layer;
the third face faces the second conductive layer;
the second protruding portions are provided in the third face;
the fourth face is an opposite face of the third face;
the second recessed portions are provided in the fourth face and lie next to one another so as to correspond one-for-one to the second protruding portions;
the first protruding portions penetrate through the first conductive layer;
the first protruding portions further penetrate into the support layer;
the second protruding portions penetrate through the second conductive layer;
the second protruding portions further penetrate into the support layer; and
the second extended part continues to the first extended part at an end portion on the opposite side from a second fixed part side and is provided integrally with the first extended part.

5. A battery comprising:
an electrode body; and
an external terminal, wherein:
the electrode body includes a first electrode, a second electrode, and a separator;
the first electrode includes a current collector and an active material layer;
the current collector includes a support layer, a first conductive layer, and a tab;
the support layer is made of a resin composition having electrical insulation properties;
the first conductive layer is laminated on the support layer;
the tab includes a first fixed part and a first extended part;
the first fixed part and the first extended part are made of metal and provided integrally;
the first fixed part extends along the first conductive layer;
the first extended part is extended from the first fixed part;
the first fixed part includes a plurality of first protruding portions;
the first fixed part is fixed on the first conductive layer by the first protruding portions penetrating into the first conductive layer;
the active material layer is laminated on the first conductive layer;
the separator is laminated on the active material layer;
the second electrode is laminated on the active material layer through the separator; and
the external terminal is electrically connected to the tab.
